(19) United States
(12) Patent Application Publication
(10) Pub. No.: US 2018/0320930 A1
(43) Pub. Date: Nov. 8, 2018

(54) OCTAHEDRAL SPACE FRAMES AND ASSOCIATED SYSTEMS AND METHODS

(71) Applicant: SKYFUEL, INC., Lakewood, CO (US)

(72) Inventors: Ryan Michael Clark, Golden, CO (US); Jennifer McDaniel, Arvada, CO (US); Harrison A. Filas, Littleton, CO (US); Nathan Schuknecht, Golden, CO (US); Emanuel Guzman, Lakewood, CO (US); David L. White, Denver, CO (US)

(21) Appl. No.: 15/587,586

(22) Filed: May 5, 2017

(51) Int. Cl. F24J 2/04; B32B 3/12; B32B 3/28; F24J 2/12; F24J 2/38

(52) U.S. Cl. CPC F24J 2/0477; B32B 3/12; B32B 3/28; B32B 2551/00; F24J 2/38; B32B 2307/416; B32B 2307/544; F24J 2/12

(57) ABSTRACT

An octahedral space frame includes a first plurality of double octahedral structures disposed in a first row in a longitudinal direction, adjacent ones of the first plurality of double octahedral structures sharing two common members. Each of the first plurality of double octahedral structures includes respective first and second single octahedron structures joined in a transverse direction and sharing three common members, the transverse direction being orthogonal to the longitudinal direction.

### BACKGROUND

Solar thermal power plants, also called concentrating solar power plants, concentrate sunlight to heat a fluid and transport the thermal energy of the heated fluid to drive a process such as electricity-generating turbines or engines. The fluid flows through concentrating solar collector assemblies, which include parabolic troughs and receiver tube(s). The parabolic troughs include a reflective surface that reflects the incident sunlight onto the receiver, through which the fluid flows. The parabolic trough, together with the receiver, may be rotated to track the sun. A space frame provides structural support for the parabolic trough. The space frame experiences significant torsional loads caused, for example, by wind. The space frame must hold the weight of the parabolic trough, particularly as it is rotated, and not fail under the torsional loads. The space frame must further provide sufficient stiffness, such that the parabolic troughs do not deflect from the desired position for optimal collection of light. With all these requirements, the space frame may account for approximately 25% of the total installation cost of a concentrating solar collector assembly.

### BRIEF SUMMARY OF THE INVENTION

Applicant has developed octahedral space frames that are capable of efficiently carrying torsional loads while maintaining torsional stiffness. In certain embodiments, the octahedral space frames support a parabolic trough of a concentrating solar collector assembly. In particular embodiments, the octahedral space frames include a plurality of double octahedral structures, disposed in a row, each double octahedral structure including two single octahedron structures. Certain embodiments of the featured octahedral space frames include a V-shaped opening formed when viewing the octahedral space frame in a longitudinal direction. Certain embodiments include a parabolic trough supported in the V-shaped opening of the octahedral space frame.

In an aspect, an octahedral space frame includes a first plurality of double octahedral structures disposed in a first row in a longitudinal direction, adjacent ones of the first plurality of double octahedral structures sharing two common members. In an embodiment of this aspect, each of the first plurality of double octahedral structures includes respective first and second single octahedron structures joined in a transverse direction and sharing three common members, the transverse direction being orthogonal to the longitudinal direction.

In an embodiment, for example, the first plurality of double octahedral structures collectively forms a V-shaped opening, as seen when the octahedral space frame is viewed in the longitudinal direction.

In an embodiment, for example, the V-shaped opening has an internal angle greater than 0 degrees and less than or equal to 180 degrees.

In an embodiment, for example, each of the first plurality of double octahedral structures includes twenty one members.

In an embodiment, for example, each of the twenty one members of each of the first plurality of double octahedral structures has equal length.

In an embodiment, for example, the octahedral space frame has a rectangular outline as seen when viewed in the longitudinal direction.

In an embodiment, for example, each of the first plurality of double octahedral structures includes twenty one members, wherein seven members of the twenty one members have a common first length and fourteen members of the twenty one members have a common second length, the second length being different from the first length.

In an embodiment, for example, the octahedral space frame further includes: a first axial chord joining each first single octahedron structure of the first plurality of double octahedral structures in the longitudinal direction; and a second axial chord joining each second single octahedron structure of the first plurality of double octahedral structures in the longitudinal direction.

In an embodiment, for example, the octahedral space frame further includes: a first plurality of axial chords joining each first single octahedron structure of the first plurality of double octahedral structures in the longitudinal direction; and a second plurality of axial chords joining each second single octahedron structure of the first plurality of double octahedral structures in the longitudinal direction.

In an embodiment, for example, the octahedral space frame further includes an end member assembly disposed at an end of the first plurality of double octahedral structures. In this embodiment, the end member assembly includes: one or more first end members connected to the first single octahedral structure of an end one of the first plurality of double octahedral structures; and one or more second end members connected to the second single octahedral structure of the end one of the first plurality of double octahedral structures.

In an embodiment, for example, the octahedral space frame further includes a torque transfer assembly disposed at the end one of the first plurality of double octahedral structures.

In an embodiment, for example, the torque transfer assembly includes at least one torque transfer plate and a central torsion element.

In an embodiment, for example, the octahedral space frame further includes a second plurality of double octahedral structures disposed in a second row in the longitudinal direction, adjacent ones, in the longitudinal direction, of the second plurality of double octahedral structures sharing two common members, the first and second rows being joined in the transverse direction.

In an embodiment, for example, each of the second plurality of double octahedral structures includes twenty one members.

In an embodiment, for example, the first and second rows share at least one common axial chord.

In an embodiment, for example, the octahedral space frame further includes a third plurality of double octahedral structures disposed in a third row in the longitudinal direction, adjacent ones, in the longitudinal direction, of the third plurality of double of octahedral structures sharing two common members, the third row being joined to each of the first and second rows in a vertical direction orthogonal to each of the longitudinal and transverse directions.

In another aspect, a concentrating solar collector assembly includes an octahedral space frame. In an embodiment of this aspect, the octahedral space frame includes a plurality of double octahedral structures disposed in a first row in a longitudinal direction, adjacent ones of the plurality of double octahedral structures sharing two common members, the plurality of double octahedral structures collectively forming a V-shaped opening in the octahedral space frame, as seen when the octahedral space frame is viewed in the longitudinal direction. In an embodiment of this aspect, each of the plurality of double octahedral structures includes respective first and second single octahedron structures joined in a transverse direction and sharing three common members, the transverse direction being orthogonal to the longitudinal direction. In an embodiment of this aspect, the octahedral space frame further includes a parabolic trough disposed in the V-shaped opening in the octahedral space frame.

In an embodiment, for example, the V-shaped opening has an internal angle greater than 0 degrees and less than or equal to 180 degrees.

In an embodiment, for example, the concentrating solar collector assembly further includes a receiver configured to carry a heat transfer fluid, the parabolic trough being configured to reflect light incident on the parabolic trough onto the receiver.

In an embodiment, for example, the concentrating solar collector assembly further includes receiver support elements configured to structurally support the receiver.

In an embodiment, for example, the receiver has an elongated axis extending in the longitudinal direction.

In an embodiment, for example, the concentrating solar collector assembly further includes a fluid distribution subsystem configured to circulate the heat transfer fluid through the receiver.

In an embodiment, for example, each of the plurality of double octahedral structures of the octahedral space frame includes twenty one members.

In an embodiment, for example, each of the twenty one members of each of the plurality of double octahedral structures has an equivalent length.

In an embodiment, for example, the octahedral space frame, of the concentrating solar collector assembly, further includes: a first axial chord joining each first single octahedron structure of the plurality of double octahedral structures in the longitudinal direction; and a second axial chord joining each second single octahedron structure of the plurality of double octahedral structures in the longitudinal direction.

In an embodiment, for example, the octahedral space frame, of the concentrating solar collector assembly, further includes: a first plurality of axial chords joining each first single octahedron structure of the first plurality of double octahedral structures in the longitudinal direction; and a second plurality of axial chords joining each second single octahedron structure of the first plurality of double octahedral structures in the longitudinal direction.

In an embodiment, for example, the octahedral space frame, of the concentrating solar collector assembly, further includes an end member assembly disposed at an end of the plurality of double octahedral structures. In this embodiment, the end member assembly includes: one or more first end members connected to the first single octahedral structure of an end one of the plurality of double octahedral structures; and one or more second end members connected to the second single octahedral structure of the end one of the plurality of double octahedral structures.

In an embodiment, for example, the octahedral space frame, of the concentrating solar collector assembly, further includes a torque transfer assembly disposed at the end one of the plurality of double octahedral structures.

In an embodiment, for example, the torque transfer assembly, of the concentrating solar collector assembly, further includes at least one torque transfer plate and a central torsion element.

In an embodiment, for example, the concentrating solar collector assembly further includes: a plurality of pylons configured to support the octahedral space frame and the parabolic trough; and a tracking subsystem configured to rotate the octahedral space frame and the parabolic trough with respect to the plurality of pylons, to track an incident light source.

In another aspect, a method for supporting a parabolic trough in a concentrating solar collector assembly includes: transferring weight of the parabolic trough to an octahedral space frame including a plurality of double octahedral structures disposed in a first row in a longitudinal direction, wherein (a) adjacent ones of the plurality of double octahedral structures share two common members and (b) each of the plurality of double octahedral structures includes respective first and second single octahedron structures joined in a transverse direction and sharing three common members, the transverse direction being orthogonal to the longitudinal direction; and transferring weight of the parabolic trough and the octahedral space frame to a base surface via a plurality of pylons.

In an embodiment, for example, the method for supporting a parabolic trough further includes carrying torsional load while maintaining torsional stiffness.

In an embodiment, for example, the base surface is a ground surface.

In an embodiment, a method for capturing solar energy includes: the method for supporting a parabolic trough in a concentrating solar collector assembly; reflecting light incident on the parabolic trough onto a receiver; and circulating a heat transfer fluid through the receiver.

In an embodiment, for example, the method for capturing solar energy further includes rotating the parabolic trough and the octahedral space frame with respect to the plurality of pylons to track an incident light source.

### BRIEF DESCRIPTION OF THE DRAWINGS

FIG. 1 shows a portion of a parabolic trough system, according to an embodiment.

FIG. 2A illustrates an embodiment of a single octahedron structure. FIG. 2B illustrates two instances of the FIG. 2A single octahedron structure. FIG. 2C illustrates a double octahedral structure formed by joining the two single octahedron structure instances of FIG. 2B, according to an embodiment.

FIG. 3A illustrates a first double octahedral structure and a second double octahedral structure. FIG. 3B shows a plurality of double octahedral structures formed when first and second double octahedral structures are joined, in an embodiment.

FIG. 4 illustrates an octahedral space frame, according to an embodiment.

FIG. 5 illustrates an octahedral space frame, according to another embodiment.

FIGS. 6A and 6B illustrate side views of an octahedral space frame, in an embodiment, viewed in the longitudinal and the transverse directions, respectively.

FIG. 7 illustrates a parabolic trough supported by an octahedral space frame, according to an embodiment.

FIG. 8 shows a side view of the parabolic trough system of FIG. 7, viewed in the longitudinal direction.

FIGS. 9A, 9B, and 9C show a top view, a longitudinal side view, and a transverse side view of an octahedral space frame, according to an embodiment.

FIGS. 10A-10C illustrate alternate embodiments of the single octahedron structure of FIG. 2A which are irregular octahedrons in their shape, wherein members have two or more lengths.

FIGS. 11A-11C illustrate side views, in the longitudinal direction, of several examples of a double octahedron structure, the examples differing in shape of the single octahedron structures, according to an embodiment. FIG. 11A shows an embodiment of a double octahedral structure that includes single octahedron structures that resemble a regular octahedron. FIGS. 11B and 11C show additional examples of double octahedral structure that include single octahedron structures that resemble irregular octahedrons.

FIGS. 12A, 126, and 12C illustrate a top view, a longitudinal side view, and a transverse side view of an octahedral space frame, according to an embodiment, including irregular single octahedron structures such as that shown in FIG. 10C, wherein the internal angle of the V-shaped opening is 180 degrees, such as shown in FIG. 11B.

FIGS. 13A-136 illustrate side views in a transverse direction and a longitudinal direction, respectively, of an embodiment of an octahedral space frame including double octahedral structures joined in a vertical direction, according to an embodiment.

FIG. 14 depicts an operational method, in an embodiment, for supporting a parabolic trough using an octahedral space frame in a concentrating solar collector assembly and for capturing solar energy.

### DETAILED DESCRIPTION OF THE EMBODIMENTS

In general the terms and phrases used herein have their art-recognized meaning, which can be found by reference to standard texts, journal references and contexts known to those skilled in the art.

Referring to the drawings, like numerals indicate like elements and the same number appearing in more than one drawing refers to the same element.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

Applicant discloses space frames and associated systems and methods where face- and/or edge-sharing octahedral structures are configured to produce a multi-layer grid space frame. Certain embodiments of the space frames form a planar surface, complex surface, or a combination of planer and complex surfaces. The space frames are used, for example, as a support structure for a parabolic trough used in a concentrated solar power application. Each space frame, henceforward referred to as an octahedral space frame, includes multiple pairs of face sharing double octahedral structures repeated along an axis and sharing edges to produce a long structure for supporting a parabolic trough, in certain embodiments.

Certain embodiments of the octahedral space frames provide structural support when used with parabolic troughs, as part of a concentrating solar collector assembly. The octahedral space frames efficiently carry a torsional load, while maintaining torsional stiffness, with low overall weight.

A further advantage of certain embodiments of the octahedral space frames is reduced complexity. In certain embodiments, members (e.g., struts and/or chords) are of the same length, thereby allowing the majority of struts used in the manufacture of an octahedral space frame to be of the same length. In this embodiment, the octahedral space frame takes a form desirable for a parabolic trough application in which the parabolic trough is cradled in the V-shape defined by the structure. As a result, additional space frame elements may be unnecessary or minimal to support the parabolic trough. The octahedral space frames featured herein provide reduced installation cost compared to conventional space frames.

Certain configurations of the octahedral space frames could also have utility in the architectural, civil, structural and other engineering fields where a configurable, multi-layer grid space frame structure is desirable.

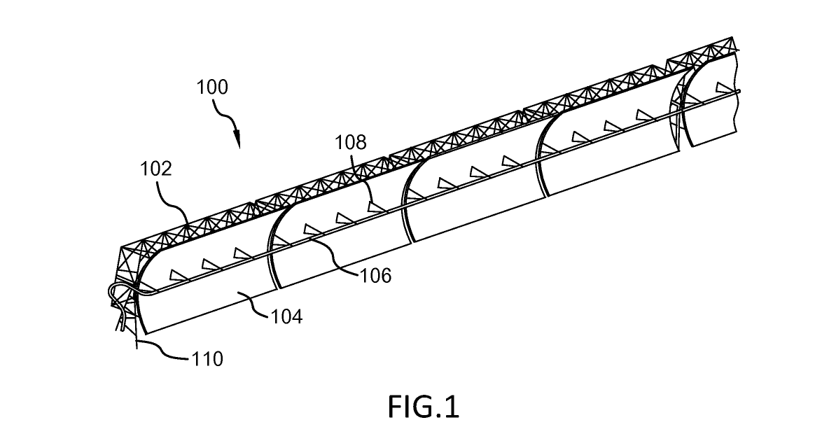

FIG. 1 shows a portion of an exemplary parabolic trough system 100, including an octahedral space frame 102. Parabolic trough system 100 is, for example, part of a concentrating solar collector assembly of a solar concentrating solar power system. Octahedral space frame 102 supports one or more parabolic troughs 104. Parabolic troughs 104 reflect incident ambient light onto a receiver 106, which is structurally supported by a receiver support elements 108. Pylons 110 provide structural support to the parabolic trough system. Parabolic trough system 100 may include one or more parabolic troughs 104 supported by one or more octahedral space frames 102.

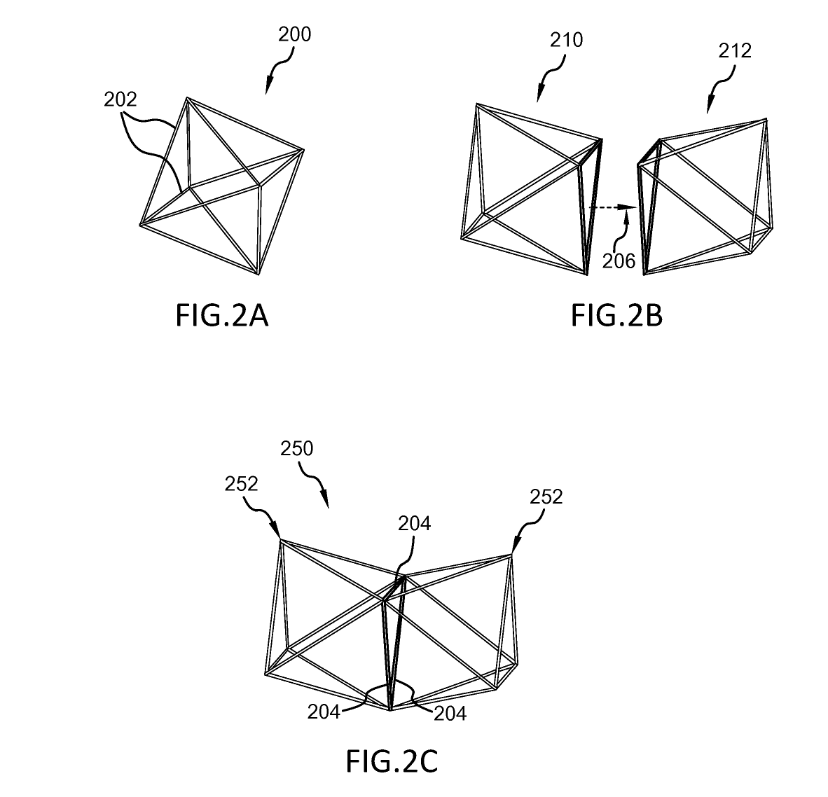

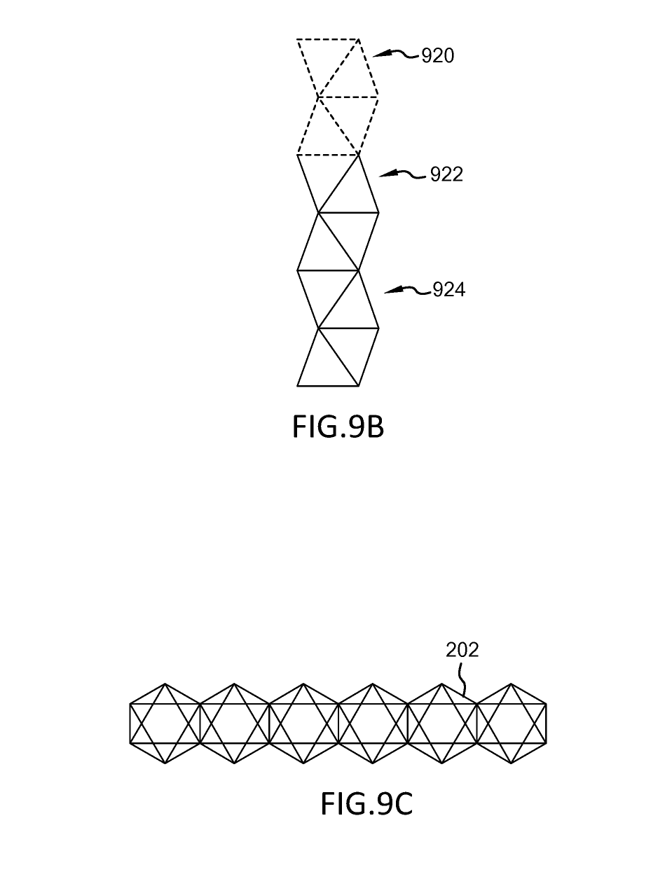

An octahedral space frame includes one or more double octahedral structures, each of which includes two single octahedron structures. FIG. 2A illustrates a single octahedron structure 200, which is formed of 12 members (e.g., struts and/or chords) 202. For illustration purposes, only two of the twelve (12) members 202 are explicitly called out in FIG. 2A. In an embodiment, single octahedron structure 200 is a regular octahedron in its shape, where each of members 202 share one common length. In certain other embodiments, single octahedron structure 200 is an irregular octahedron in its shape, such as that depicted in any of FIGS. 10A-10C, for example, where members 202 have two, three, four, or five different lengths within single octahedron 200. FIG. 2B illustrates a first single octahedron structure 210 and a second octahedron structure 212, each of which is an embodiment of single octahedron structure 200. First and second octahedron structures 210 and 212 are preferably equivalent to each other. First and second octahedron structures 210 and 212 are effectively joined, in a transverse direction 206, as illustrated in FIG. 2C, such that three members (e.g., struts and/or chords) 204 are shared in the resulting embodiment of a double octahedral structure 250. Shared members 204 are embodiments of members 202. Double octahedral structure 250 includes twenty one (21) members (e.g., struts and/or chords) 202, including shared members 204. In an embodiment, each of the twenty one members 202, including shared members 204, of double octahedral structure 250 are of equal length. In certain other embodiments, the twenty one members 202, including shared members 204, of double octahedral structure 250 have two, three, four, or five different lengths.

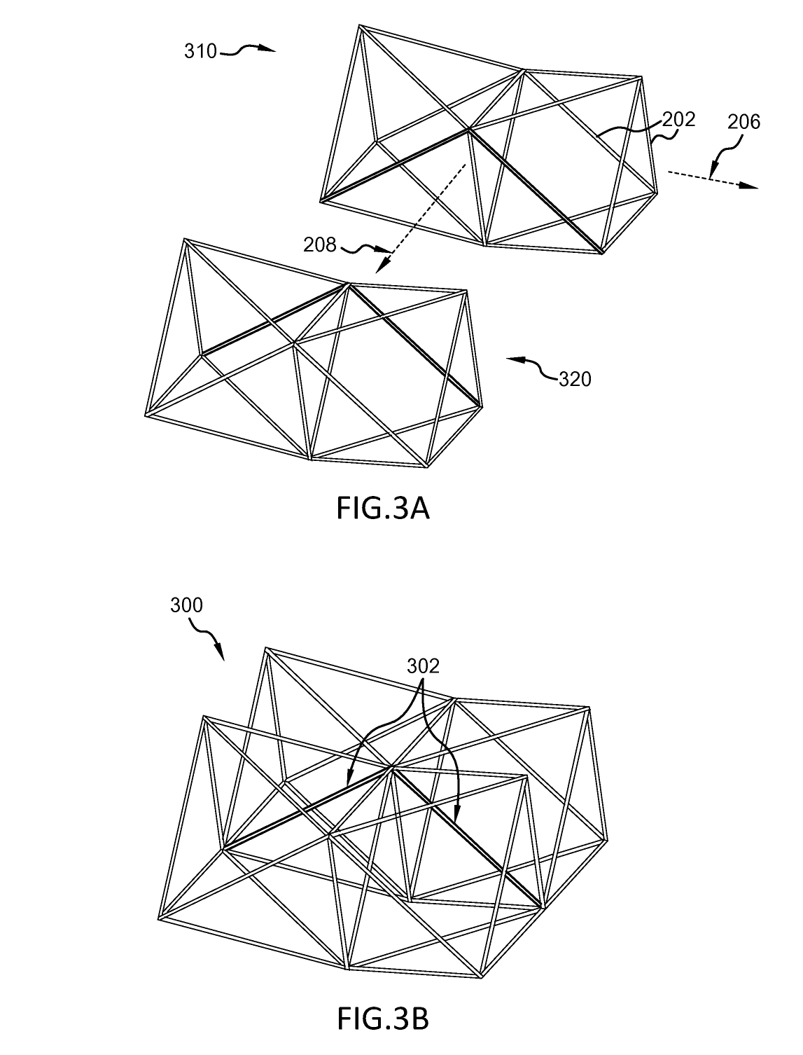

FIG. 3A illustrates a first double octahedral structure 310 and a second double octahedral structure 312, each of which are embodiments of double octahedral structure 250. First and second double octahedral structures 310 and 312 are preferably equivalent to each other. First and second double octahedral structures 310 and 312 are formed of members 202, only two of which are explicitly called out for illustration purposes. FIG. 3B shows a plurality (i.e., two) of double octahedral structures 300 formed when first and second double octahedral structures 310 and 312 are effectively joined, in a longitudinal direction 208, which is orthogonal to transverse direction 206, such that two members 302 of first and second octahedral structures 310 and 312 are shared in resulting plurality of double octahedral structures 300. Shared members 302 are embodiments of members 202. In an embodiment, each of members 202, including shared members 302, in plurality of octahedral structures 300 is of equal length. In certain other embodiments, the members 202, including shared members 302, of plurality of double octahedral structures 300 have two, three, four, or five different lengths. In certain embodiments, plurality of double octahedral structures 300 includes three or more effectively joined double octahedral structures, such as 250, 310, and 312.

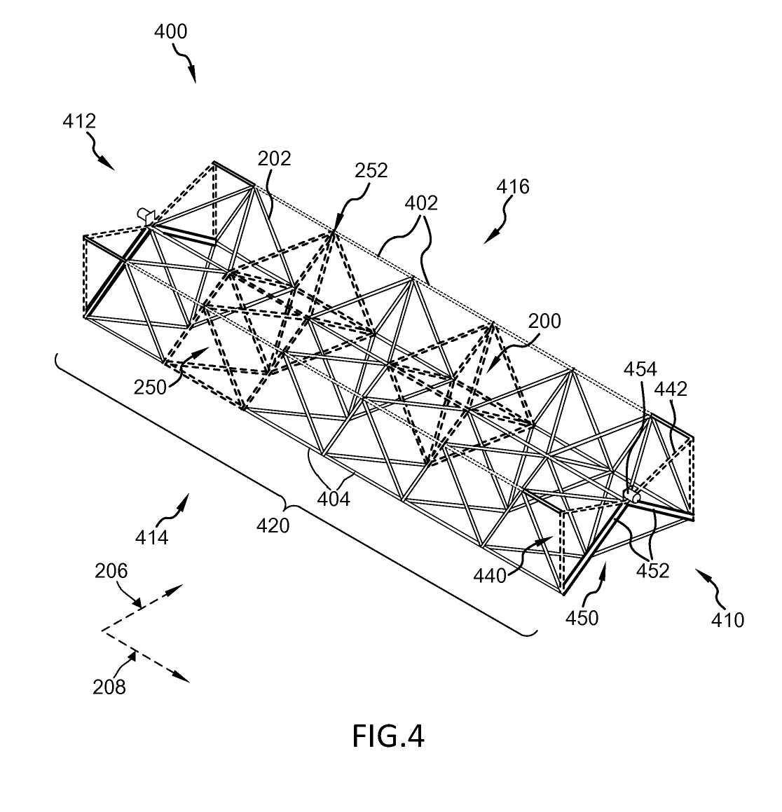

FIG. 4 illustrates an octahedral space frame 400, which is one possible embodiment of the octahedral space frames featured herein. Octahedral space frame 400 includes a plurality of double octahedral structures 420, which are an embodiment of plurality of double octahedral structures 300, disposed in a row in longitudinal direction 208. Plurality of double octahedral structures 420 includes six double octahedral structures 250, one of which is labeled in FIG. 4, effectively joined in longitudinal direction 208, any two adjacent double octahedral structures 250 share two common members. Other embodiments of the octahedral space frames featured herein include a different number of double octahedral structures 250 in plurality of double octahedral structures 420, without departing from the scope hereof. Octahedral space frame 400 includes first longitudinal end 410 and second longitudinal end 412, which are opposite of each other along longitudinal direction 208. Octahedral space frame 400 also includes first transverse side 414 and second transverse side 416, which are opposite each other along transverse direction 206. For illustration and clarity purposes, only one single octahedron structure 200 is labeled in FIG. 4. Octahedral space frame 400 includes axial chords 404, which are embodiments of members 202. Three series of six linearly connected axial chords 404 run in longitudinal direction 208 between first longitudinal end 410 and second longitudinal end 412 ultimately connecting ends of torque transfer plates 452 at first longitudinal end 410 to the corresponding ends of torque transfer plates 452 at second longitudinal end 412 of octahedral space frame 400, as illustrated in FIG. 4. In other embodiments, the number of axial chords 404 connected in series between first and second longitudinal ends 410 and 412 is n, where n is the number of double octahedral structures 250 effectively joined in longitudinal direction 208 within plurality of double octahedral structures 420. In certain embodiments, any number of members 404 may be struts, for example. Octahedral space frame 400 further includes axial chords 402. Two series of five linearly connected axial chords 402 run in longitudinal direction 208 between first longitudinal end 410 and second longitudinal end 412, axial chords 402 of each series connecting upper vertices 252 of each longitudinally adjacent double octahedral structure 250, within plurality of double octahedral structures 420, on respective first or second transverse side 414 or 416. In other words, axial chords 402 in a first series join each adjacent first single octahedron structure 210 and axial chords 402 in a second series join each adjacent second octahedron structure 212, in longitudinal direction 208. In other embodiments, the number of axial chords 402 connected in each series, or in other words, the number of axial chords 402 connecting each first single octahedron structure 210 and the number of axial chords 402 connecting each second octahedron structure 212, is (n-1). Other embodiments of the octahedral space frames featured herein include a different number of axial chords 402, without departing from the scope hereof. For example, one axial chord 402 may span two single octahedron structures 200, or any other number of single octahedron structures within octahedral space frame 400. In an embodiment, the length of each axial chord 404 is approximately the length of each strut member within the single octahedron structures. In an embodiment, the length of axial chord 402 is equal to the distance between any two upper vertices 252 that axial chord 402 connects.

Octahedral space frame 400 further includes an end member assembly 440 proximate each of first and second longitudinal ends 410 and 412. In this embodiment, each end member assembly 440 includes end axial chords 406 and end members 442. Each end axial chord 406 is connected to nearest upper vertex 252 proximate the respective longitudinal end, 410 or 412, and respective transverse side, 414 or 416, to proximate end members 442 at respective longitudinal end and respective transverse side of octahedral space frame 400, as illustrated in FIG. 4. In other words, proximate each longitudinal end, 410 and 412, an end axial chord 406 connects proximate first single octahedron structure to proximate end members 442, and another end axial chord 406 connects proximate second single octahedron structure to proximate end members 442. End members 442 connect proximate end axial chords 406 and proximate ends of torque transfer plates 452, as depicted in FIG. 4, in an embodiment. In other embodiments, end member assembly 440 may include other quantities of end axial chords 406 and of end members 442. In certain embodiments, each end axial chord 406 may be cantilevered, such that an end portion of end chord 406 is cantilevered, optionally supported by other structural members such as brackets other than struts. End members 442 are embodiments of members 202, and may be struts. Octahedral space frame 400 includes a torque transfer assembly 450 at each of first and second longitudinal ends 410 and 412. At each of first and second longitudinal ends 410 and 412, a central torsion element 454 is located proximate where inner ends of torque transfer plates 452 and an axial chord 404 connect. The center of central torsion element 454 is coincident with the rotational axis of parabolic trough 104.

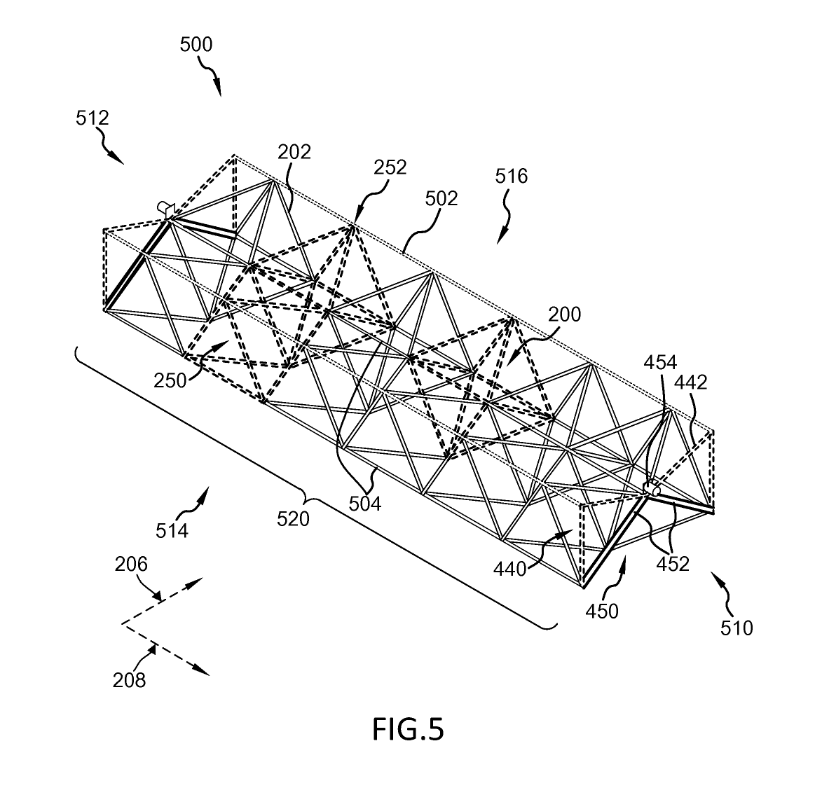

FIG. 5 illustrates an octahedral space frame 500, which is another possible embodiment of the octahedral space frame featured herein. Octahedral space frame 500 includes axial chords 502. One axial chord 502 spans the length of octahedral space frame 500, from first longitudinal end 510 to second longitudinal end 512, connecting upper vertex 252 of each first single octahedron structure of each double octahedral structure 250 within plurality of double octahedral structures 420. Another axial chord 502 spans the length of octahedral space frame 500, from first longitudinal end 510 to second longitudinal end 512, connecting upper vertex 252 of each second single octahedron structure of each double octahedral structure 250 within plurality of double octahedral structures 420. In other embodiments, octahedral space frame 500 may include more than three axial chords 502. Octahedral space frame 500 further includes axial chords 504. Each axial chord 504 runs from an end of torque transfer plates 452 to a corresponding end of torque transfer plates 452 between first longitudinal end 510 and second longitudinal end 512, as illustrated in FIG. 5. For example, one of axial chords 504 spans the length of octahedral space frame 500 between central torsion element 454 at first longitudinal end 510 and central torsion element 454 at second longitudinal end 512. In certain embodiments, axial chords 502 and axial chords 504 are equivalent. Other features of octahedral space frame 500 are common with octahedral space frame 400.

In certain embodiments, the octahedral spaces frame featured herein may have any combination of features of octahedral space frame 400 and octahedral space frame 500.

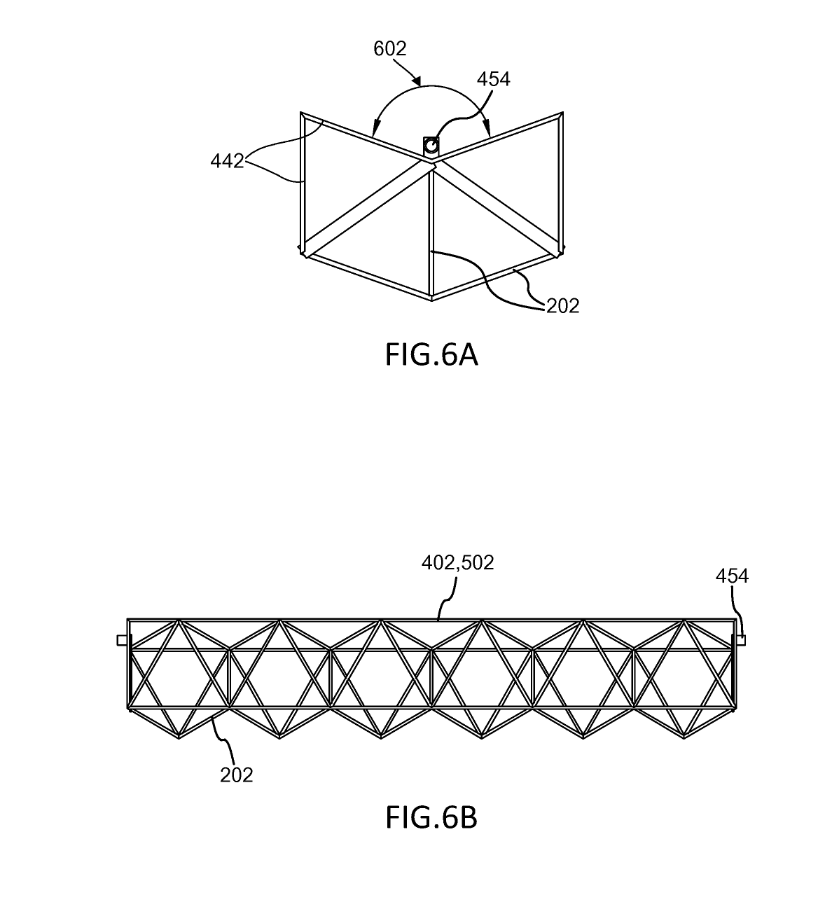

FIG. 6A illustrates a side view of an octahedral space frame, in an embodiment octahedral space frame 400, viewed in longitudinal direction 208. A V-shaped opening is formed at the upper portion of the side view of an octahedral space frame 400. Angle 602 describes the internal angle of the V-shaped opening. FIG. 6B illustrates a side view of an octahedral space frame, for example 400, viewed in transverse direction 206.

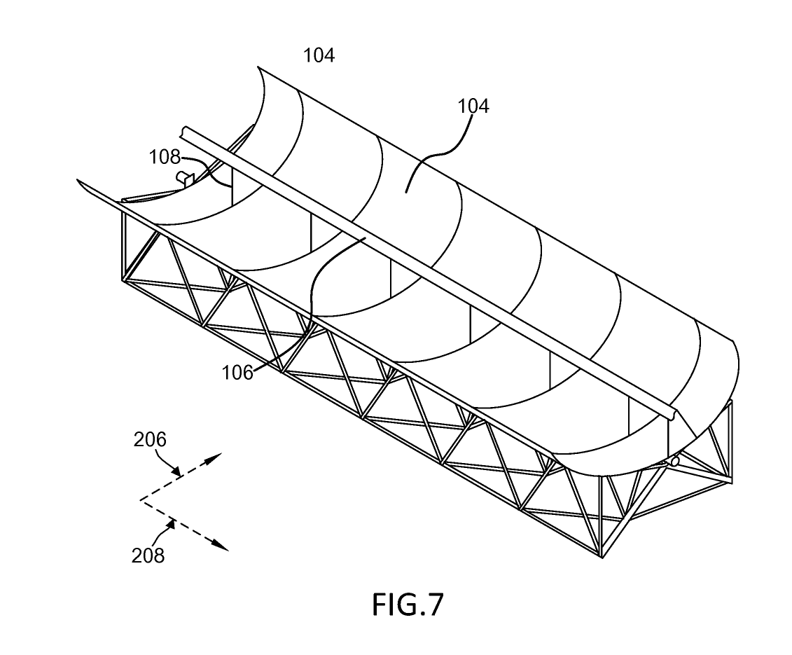

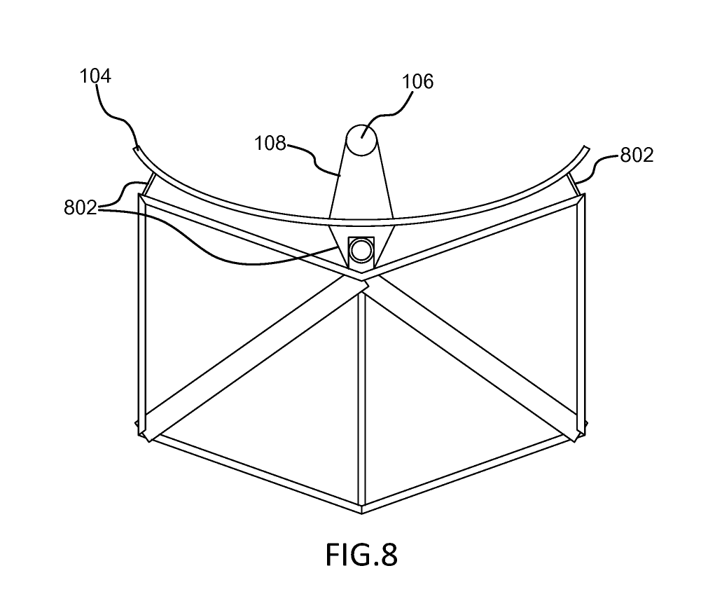

FIG. 7 illustrates parabolic trough 104 supported by an octahedral space frame, in an embodiment octahedral space frame 400. The elements shown in FIG. 7 may be part of parabolic trough system 100, in an embodiment, and further part of a concentrating solar collector assembly. Receiver 106 is structurally supported by receiver support elements 108. Parabolic trough 104 is configured to reflect incident light, such as sunlight, onto receiver 106, which carries a heat transfer fluid. Receiver 106 has an elongated axis extending in longitudinal direction 208. FIG. 8 shows a side view of the parabolic trough system of FIG. 7, in an embodiment, viewed in longitudinal direction 208. In an embodiment, parabolic trough support elements 802 provide structural support to parabolic trough 104 disposed in the V-shaped opening of octahedral space frame 400. In an embodiment, parabolic trough support elements 802 are brackets or struts.

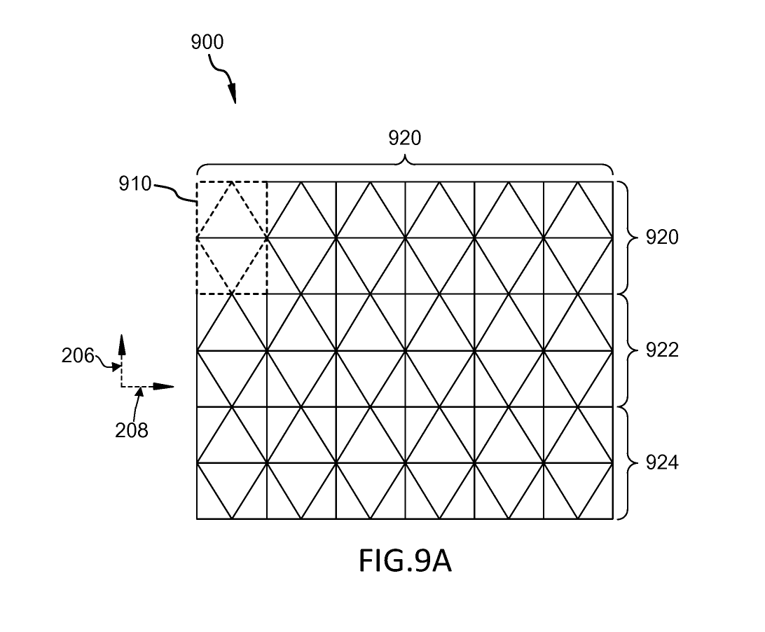

Certain embodiments of the octahedral space frame featured herein include more than one plurality of double octahedral structures 300, effectively joined in transverse direction 206, and one or more double octahedral structures 250 included in each plurality of double octahedral structures 300. For example, FIGS. 9A-9C show a top view, longitudinal side view, and a transverse side view, respectively, of an embodiment of the octahedral space frames featured herein. In this embodiment, an octahedral space frame 900 includes three pluralities of double octahedral structures 920, 922, and 924, effectively sequentially joined in transverse direction 206, each of plurality of double octahedral structures 920, 922, and 924 including six double octahedral structures 910 effectively sequentially joined in longitudinal direction 208. For illustration purposes, only members 202 of octahedral space frame 900 are shown. In other embodiments, octahedral space frame 900 includes features of octahedral space frame 400 and/or 500, for example.

FIGS. 10A-10C illustrate alternate embodiments of single octahedron structure 200 which are irregular octahedrons in their shape, wherein members have two or more lengths.

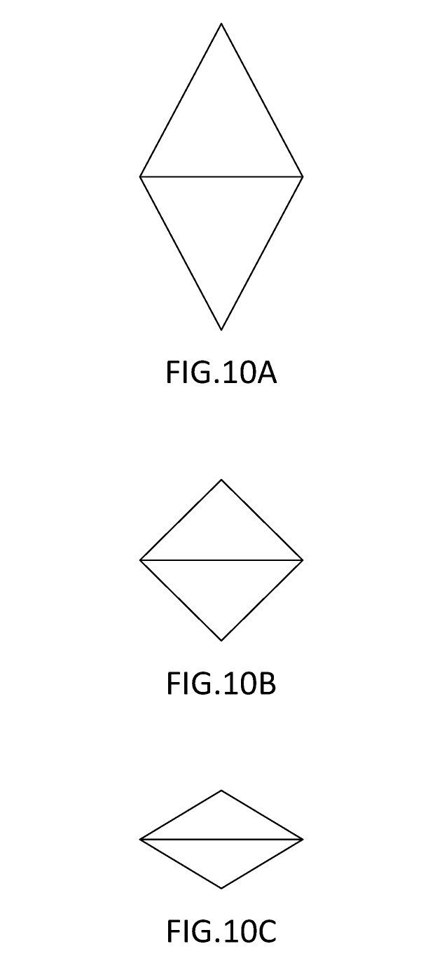

FIGS. 11A-11C illustrate side views, in longitudinal direction 208, of certain example embodiments of double octahedron structure 250, the examples differing in shape of comprising single octahedron structures. FIG. 11A shows an embodiment of double octahedral structure 300 that includes single octahedron structures that resemble a regular octahedron. In this embodiment, angle 602 is approximately 141 degrees. FIGS. 11B and 11C show embodiments of double octahedral structure 300 that include single octahedron structures that resemble irregular octahedrons, such that angle 602 is 180 degrees and 90 degrees, respectively. In other embodiments, angle 602 may be greater than 0 degrees and less than or equal to 180 degrees.

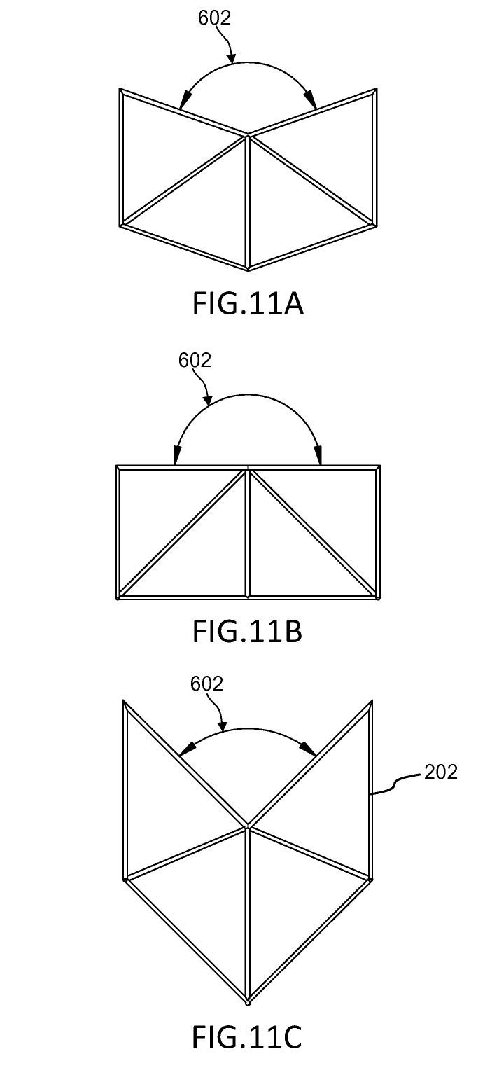

Certain embodiments of the octahedral space frame featured herein include single octahedron structures 200 that are irregular octahedrons in their shape, such as those illustrated in FIGS. 10A-10C. FIGS. 12A-12C illustrate a top view, a longitudinal side view, and, and a transverse side view, of an embodiment of the octahedral space frames featured herein. In this embodiment, an octahedral space frame 1200 includes irregular single octahedron structures 1210 such as that shown in FIG. 10C, wherein angle 602 is 180 degrees, as depicted in FIG. 11B, for example. Octahedral space frame 1200 includes three pluralities of double octahedral structures 1220, 1222, and 1224, effectively sequentially joined in transverse direction 206, each of plurality of double octahedral structures 1220, 1222, and 1224 including six double octahedral structures 1210 effectively sequentially joined in longitudinal direction 208. For illustration purposes, only members 202 of octahedral space frame 1200 are shown. In other embodiments, octahedral space frame 1200 includes features of octahedral space frame 400 and/or 500, for example.

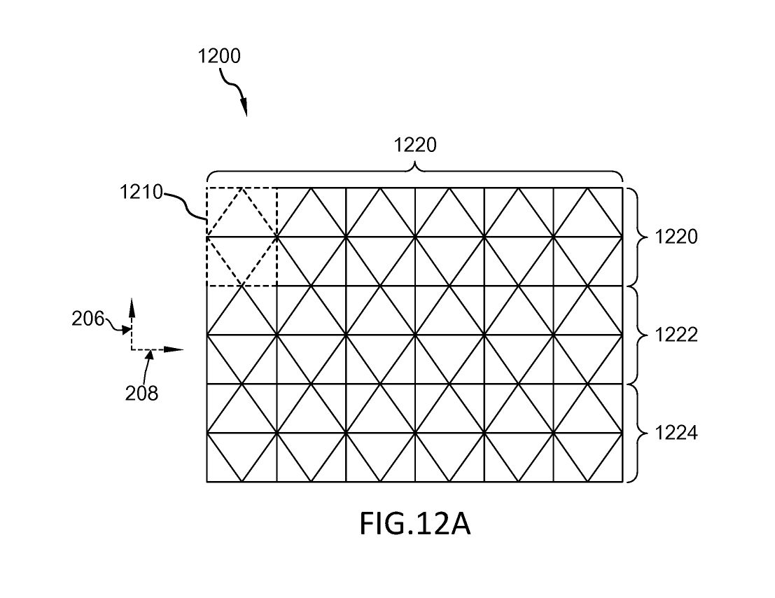

In other embodiments, an octahedral space frame includes double octahedral structures effectively joined in a vertical direction 1302, which is orthogonal to longitudinal and transverse directions 208 and 206. FIGS. 13A and 13B illustrate side views in transverse direction 206 and longitudinal direction 208, respectively, of an example embodiment of octahedral space frames featured herein. In this embodiment, an octahedral space frame 1300 includes pluralities of double octahedral structures 1320, which include double octahedral structures 1310, effectively joined in vertical direction 1302. For illustration purposes, only members 202 of octahedral space frame 1300 are shown. In other embodiments, octahedral space frame 1300 includes features of octahedral space frame 400 and/or 500, for example.

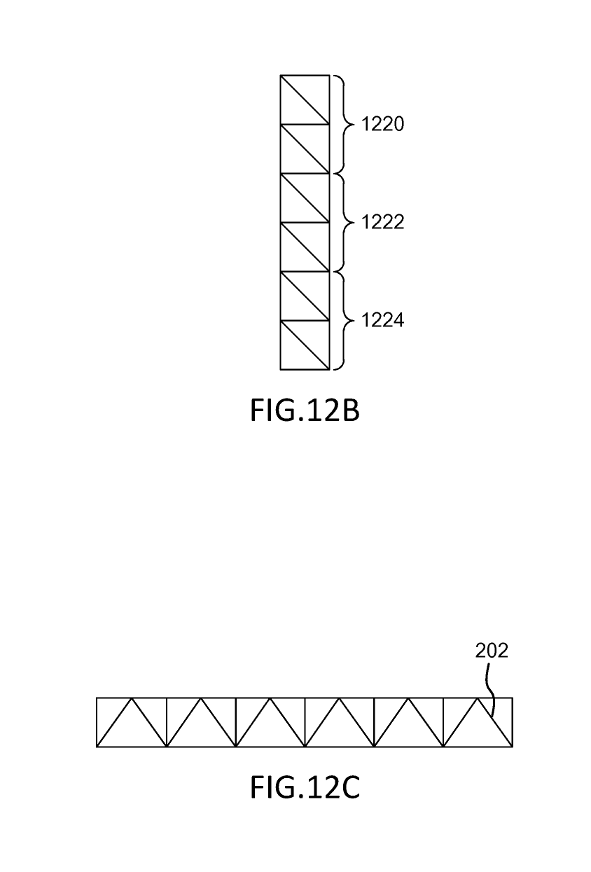

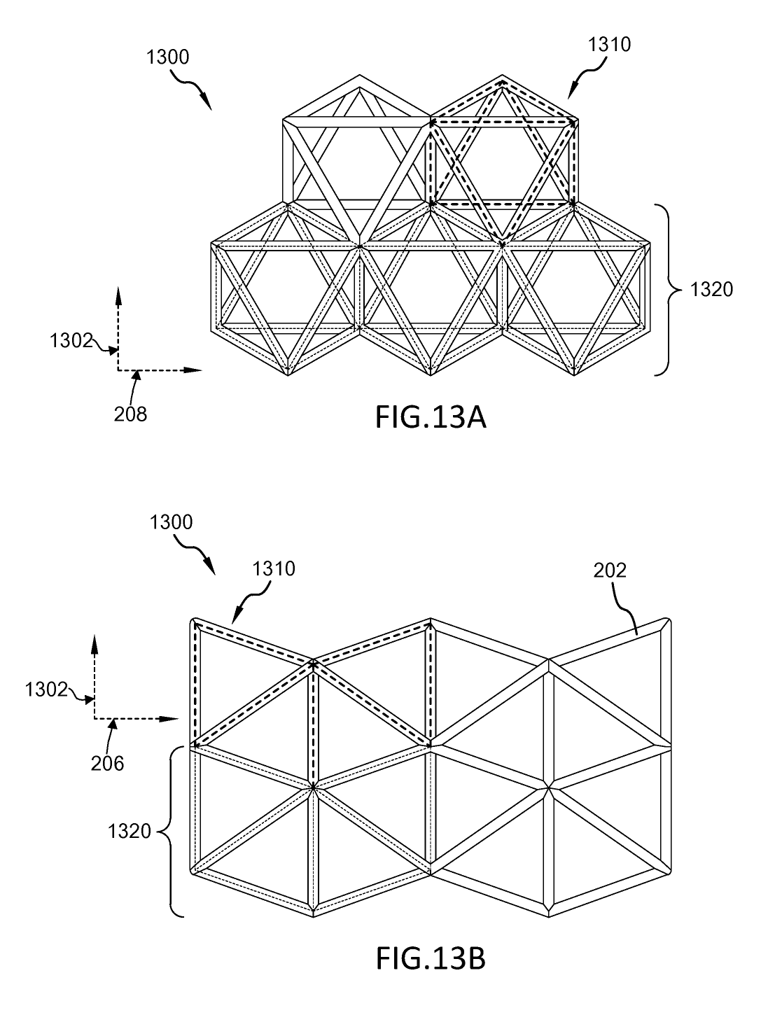

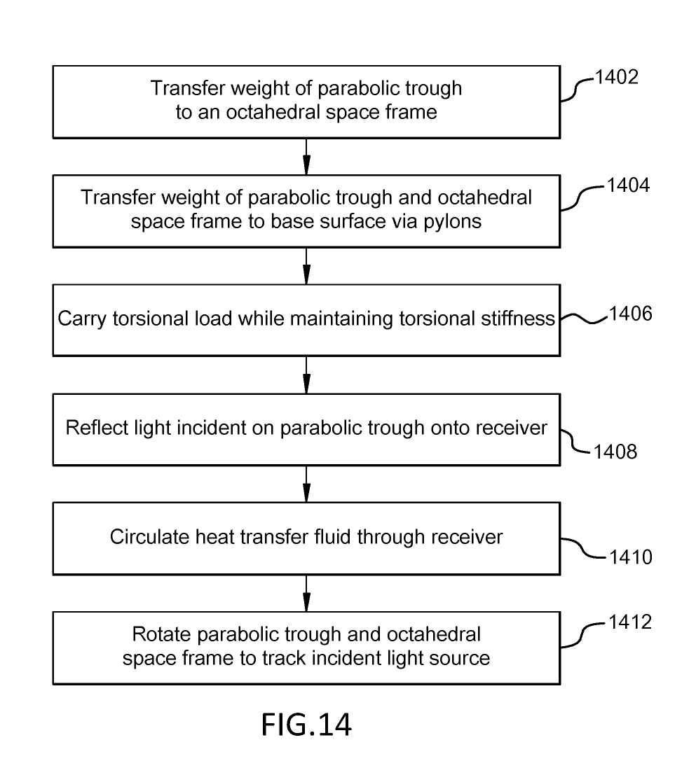

FIG. 14 depicts an operational method 1400, in an aspect, for supporting a parabolic trough using an octahedral space frame in a concentrating solar collector assembly and for capturing solar energy. In an embodiment of method 1400, the parabolic trough is parabolic trough 104 and the octahedral space frame is octahedral space frame 400. In step 1402, the weight of parabolic trough 104 is transferred onto octahedral space frame 400, for example. In step 1404, the weight of parabolic trough 104 and octahedral space frame 400, for example, is transferred to a base surface, such as a ground surface, via pylons 110. In step 1406, torsional load is carried by octahedral space frame 400, for example, while maintaining torsional stiffness. In step 1408, light incident on parabolic trough 104 is reflected onto a receiver, such as receiver 106. In step 1410, a heat transfer fluid, such as an oil, steam, or molten salt, is circulated through the receiver. In step 1412, parabolic trough 104 and octahedral space frame 400, for example, are rotated to track an incident light source, such as the sun. Although FIG. 14 illustrates steps 1402-1412 being serially performed for illustrative convenience, it is anticipated that some or all of steps 1402-1412 will frequently be performed in parallel.

### Statements Regarding Variations

Having now fully described the present invention in some detail by way of illustration and examples for purposes of clarity of understanding, it will be clear to one of ordinary skill in the art that the same can be performed by modifying or changing the invention within a wide and equivalent range of conditions, formulations and other parameters without affecting the scope of the invention or any specific embodiment thereof, and that such modifications or changes are intended to be encompassed within the scope of the appended claims.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. Methods and devices useful for the present methods can include a large number of optional composition and processing elements and steps.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a”, “an”, and “the” include plural reference unless the context clearly dictates otherwise. Thus, for example, reference to “a heating pipe” includes a plurality of such heating pipes and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Although any methods and materials similar or equivalent to those described herein can be used in the practice or testing of the present invention, the preferred methods and materials are now described. Nothing herein is to be construed as an admission that the invention is not entitled to antedate such disclosure by virtue of prior invention.

Whenever a range is given in the specification, for example, a temperature range, a time range, or a composition or concentration range, all intermediate ranges and subranges, as well as all individual values included in the ranges given are intended to be included in the disclosure. As used herein, ranges specifically include the values provided as endpoint values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms. “comprising”, “consisting essentially of” and “consisting of” may be replaced with either of the other two terms.

Herein, and unless otherwise indicated, the term “exemplary” means serving as an example, instance, or illustration.

One of ordinary skill in the art will appreciate that device elements and combinations of components other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. An octahedral space frame, comprising:
a first plurality of double octahedral structures disposed in a first row in a longitudinal direction, adjacent ones of the first plurality of double octahedral structures sharing two common members;
each of the first plurality of double octahedral structures including respective first and second single octahedron structures joined in a transverse direction and sharing three common members, the transverse direction being orthogonal to the longitudinal direction.

2. The octahedral space frame of claim 1, the first plurality of double octahedral structures collectively forming a V-shaped opening, as seen when the octahedral space frame is viewed in the longitudinal direction.

3. The octahedral space frame of claim 2, the V-shaped opening having an internal angle greater than 0 degrees and less than or equal to 180 degrees.

4. The octahedral space frame of claim 1, each of the first plurality of double octahedral structures comprising twenty one members.

5. The octahedral space frame of claim 4, each of the twenty one members of each of the first plurality of double octahedral structures having equal length.

6. The octahedral space frame of claim 1, the octahedral space frame having a rectangular outline as seen when viewed in the longitudinal direction.

7. The octahedral space frame of claim 6, each of the first plurality of double octahedral structures comprising twenty one members, wherein seven members of the twenty one members have a common first length and fourteen members of the twenty one members have a common second length, the second length being different from the first length.

8. The octahedral space frame of claim 1, further comprising:
a first axial chord joining each first single octahedron structure of the first plurality of double octahedral structures in the longitudinal direction; and
a second axial chord joining each second single octahedron structure of the first plurality of double octahedral structures in the longitudinal direction.

9. The octahedral space frame of claim 1, further comprising:
a first plurality of axial chords joining each first single octahedron structure of the first plurality of double octahedral structures in the longitudinal direction; and
a second plurality of axial chords joining each second single octahedron structure of the first plurality of double octahedral structures in the longitudinal direction.

10. The octahedral space frame of claim 1, further comprising:
an end member assembly disposed at an end of the first plurality of double octahedral structures; the end member assembly including:
one or more first end members connected to the first single octahedral structure of an end one of the first plurality of double octahedral structures; and
one or more second end members connected to the second single octahedral structure of the end one of the first plurality of double octahedral structures.

11. The octahedral space frame of claim 10, further comprising a torque transfer assembly disposed at the end one of the first plurality of double octahedral structures.

12. The octahedral space frame of claim 11, the torque transfer assembly including at least one torque transfer plate and a central torsion element.

13. The octahedral space frame of claim 1, further comprising a second plurality of double octahedral structures disposed in a second row in the longitudinal direction, adjacent ones, in the longitudinal direction, of the second plurality of double octahedral structures sharing two common members, the first and second rows being joined in the transverse direction.

14. The octahedral space frame of claim 13, each of the second plurality of double octahedral structures comprising twenty one members.

15. The octahedral space frame of claim 13, the first and second rows sharing at least one common axial chord.

16. The octahedral space frame of claim 13, further comprising a third plurality of double octahedral structures disposed in a third row in the longitudinal direction, adjacent ones, in the longitudinal direction, of the third plurality of double of octahedral structures sharing two common members, the third row being joined to each of the first and second rows in a vertical direction orthogonal to each of the longitudinal and transverse directions.

17. A concentrating solar collector assembly, comprising:
an octahedral space frame, including:
a plurality of double octahedral structures disposed in a first row in a longitudinal direction, adjacent ones of the plurality of double octahedral structures sharing two common members, the plurality of double octahedral structures collectively forming a V-shaped opening in the octahedral space frame, as seen when the octahedral space frame is viewed in the longitudinal direction,
each of the plurality of double octahedral structures including respective first and second single octahedron structures joined in a transverse direction and sharing three common members, the transverse direction being orthogonal to the longitudinal direction; and
a parabolic trough disposed in the V-shaped opening in the octahedral space frame.

18. The concentrating solar collector assembly of claim 17, the V-shaped opening having an internal angle greater than 0 degrees and less than or equal to 180 degrees.

19. The concentrating solar collector assembly of claims 18, further comprising a receiver configured to carry a heat transfer fluid, the parabolic trough being configured to reflect light incident on the parabolic trough onto the receiver.

20. The concentrating solar collector assembly of claim 19, further comprising receiver support elements configured to structurally support the receiver.

21. The concentrating solar collector assembly of claim 19, the receiver having an elongated axis extending in the longitudinal direction.

22. The concentrating solar collector assembly of claim 19, further comprising a fluid distribution subsystem configured to circulate the heat transfer fluid through the receiver.

23. The concentrating solar collector assembly of claim 17, each of the plurality of double octahedral structures of the octahedral space frame comprising twenty one members.

24. The concentrating solar collector assembly of claim 23, each of the twenty one members of each of the plurality of double octahedral structures having equal length.

25. The concentrating solar collector assembly of claim 17, the octahedral space frame further including:
a first axial chord joining each first single octahedron structure of the plurality of double octahedral structures in the longitudinal direction; and
a second axial chord joining each second single octahedron structure of the plurality of double octahedral structures in the longitudinal direction.

26. The concentrating solar collector assembly of claim 17, the octahedral space frame further including:
a first plurality of axial chords joining each first single octahedron structure of the first plurality of double octahedral structures in the longitudinal direction; and
a second plurality of axial chords joining each second single octahedron structure of the first plurality of double octahedral structures in the longitudinal direction.

27. The concentrating solar collector assembly of claim 17, the octahedral space frame further including:
an end member assembly disposed at an end of the plurality of double octahedral structures, the end member assembly including:
one or more first end members connected to the first single octahedral structure of an end one of the plurality of double octahedral structures; and
one or more second end members connected to the second single octahedral structure of the end one of the plurality of double octahedral structures.

28. The concentrating solar collector assembly of claim 27, the octahedral space frame further including a torque transfer assembly disposed at the end one of the plurality of double octahedral structures.

29. The concentrating solar collector assembly of claim 28, the torque transfer assembly including at least one torque transfer plate and a central torsion element.

30. The concentrating solar collector assembly of claim 28, further comprising:
a plurality of pylons configured to support the octahedral space frame and the parabolic trough; and
a tracking subsystem configured to rotate the octahedral space frame and the parabolic trough with respect to the plurality of pylons, to track an incident light source.

31. A method for supporting a parabolic trough in a concentrating solar collector assembly, comprising:
transferring weight of the parabolic trough to an octahedral space frame including a plurality of double octahedral structures disposed in a first row in a longitudinal direction, wherein (a) adjacent ones of the plurality of double octahedral structures share two common members and (b) each of the plurality of double octahedral structures includes respective first and second single octahedron structures joined in a transverse direction and sharing three common members, the transverse direction being orthogonal to the longitudinal direction; and
transferring weight of the parabolic trough and the octahedral space frame to a base surface via a plurality of pylons.

32. The method of claim 31, further comprising carrying torsional load while maintaining torsional stiffness.

33. The method of claim 31, the base surface being a ground surface.

34. A method for capturing solar energy, comprising:
supporting a parabolic trough in a concentrating solar collector assembly according to the method of claim 31;
reflecting light incident on the parabolic trough onto a receiver; and
circulating a heat transfer fluid through the receiver.

35. The method of claim 34, further comprising rotating the parabolic trough and the octahedral space frame with respect to the plurality of pylons to track an incident light source.
